(19) United States
(12) Patent Application Publication
(10) Pub. No.: US 2010/0282529 A1
(43) Pub. Date: Nov. 11, 2010

(54) ELECTROCHEMICAL CELL AND ENERGY STORAGE ASSEMBLY

(75) Inventor: Peter Birke, Glinicke/Nordbahn (DE)

Correspondence Address: RATNERPRESTIA, P.O. BOX 980, VALLEY FORGE, PA, 19482, US

(73) Assignees: TEMIC Automotive Electric Motors GmbH, Berlin (DE); ENAX Inc., Bunkyo-ku Tokyo (JP)

(21) Appl. No.: 12/597,236

(22) PCT Filed: Apr. 23, 2008
(86) PCT No.: PCT/EP08/03273

§ 371 Date: Mar. 19, 2010

(30) Foreign Application Priority Data
Apr. 24, 2007 (DE) 10 2007 019 625.5
Apr. 27, 2007 (DE) 10 2007 020 465.7
May 10, 2007 (DE) 10 2007 022 436.4

(51) Int. Cl. B60K 6/20; H01M 6/12; B60K 1/00

(52) U.S. Cl. 180/65.21; 429/162; 180/65.1; 903/907

(57) ABSTRACT

An electrochemical cell with a pair of electrodes arranged as a stack of flat electrode films separated by a separator film, wherein electrode films of each electrode are electrically connected with each other through inner electrode conductors, the inner electrode conductors of the different electrodes are arranged on opposite sides of the electrochemical cell in electrode material-free area of the electrode films, each inner electrode conductor is connected with a separate inner conductor element through a predetermined number of weld points integrated in the electrode material-free area of the respective electrode.

### CROSS-REFERENCE TO RELATED APPLICATIONS

This application is the U.S. national phase application of PCT International Application No. PCT/EP2008/003273, filed Apr. 23, 2008, which claims priority to German Patent Application Serial No. 10 2007 019 625.5, filed on Apr. 24, 2007, German Patent Application Serial No. 10 2007 020 465.7, filed on Apr. 27, 2007, and German Patent Application Serial No. 10 2007 022 436.4, filed on May 10, 2007, the contents of which are hereby incorporated by reference into this application.

### FIELD OF THE INVENTION

The present invention relates to an electrochemical cell and an energy storage assembly comprising a plurality of such electrochemical cells and an electric car or a hybrid type electric car using the same. The energy storage assembly (also called battery pack) comprises a plurality of flat electrochemical cells (also called battery cells) each of them comprises a pair of electrodes which electrically connect the electrochemical cells with each other through outward terminals.

### BACKGROUND OF THE INVENTION

In order to satisfy requirements such as higher input-output power sources for applications, e.g. electric cars, hybrid cars, electric tools, etc. new energy storage assemblies, e.g. lead-acid batteries, lithium-ion batteries, nickel metal hydride batteries, nickel-cadmium batteries and electric double layer capacitors, etc. have been developed.

These new energy storage assemblies power the electric driving motor and the vehicle on-board electrical system. To control the charge-discharge procedures of the energy storage assembly a controller is integrated which manages the charge-discharge procedures, the conversion from braking energy into electric energy (=renewable braking), etc, so that the energy storage assembly can charge during vehicle operation.

The energy storage assembly or each single electrochemical cell should exhibit good characteristics such as a maximum voltage range of 100 V to 450 V with a current of 400 A and for extreme condition, e.g. high temperature, with current up to 500 A. Continuous current is in the range of 80 A to 100 A or even also higher depending on the application.

For such extreme conditions the connection of the electrochemical cells of energy storage assembly is extremely stressed.

Normally, the connections are provided through crimps, screws or weld points. Often, the electrochemical cells are damaged during setting up the connection through thermal and mechanical stress.

Accordingly, an object of the invention is to provide an electrochemical cell and an energy storage assembly whose connections shall exhibit a high reliability, e.g. up to 15 years, under extreme conditions, e.g. in a vehicle under high vibration and high temperature. Furthermore the energy storage assembly shall exhibit a good ampacity (i.e. a good current carrying capacity, whereas the connection resistance should be smaller than the internal cell resistance) and high capacity against thermal and mechanical stress.

### SUMMARY OF THE INVENTION

In order to satisfy this object, an electrochemical cell is provided with a high ampacity and a good current and thermal distribution through the novel connecting form of the electrode connection.

In accordance with an aspect of the invention, an electrochemical cell comprises a pair of electrodes arranged as a stack of flat electrode films separated by at least one separator film, wherein:
electrode films of each electrode are electrically connected with each other through inner electrode conductors,
the inner electrode conductors of the different electrodes are arranged on opposite sides of the electrochemical cell in electrode material-free area of the electrode films,
each inner electrode conductor is connected with an separate conductor element through a predetermined number of weld points in the electrode material-free area of the respective electrode.

Such an arrangement of a separate conductor element welded with the inner electrode conductors and the inner electrode films allows a high reliability with a good ampacity and current and also thermal distribution. Furthermore, the cell has a high life expectancy based on an efficient space-saving packaging of the electrode films. Such an arranged electrochemical cell can be produced simply, efficiently and very fast. The electrochemical cell comprises a high flexibility and variability in the conductor dimensions, e.g. in thickness and width of the conductors so that the cell, especially the film surface with active electrode material can be efficiently optimized for higher energy density and high space-saving of the cell.

Preferably, the separate inner conductor element is provided as a conductor bar. In a possible embodiment, the separate inner conductor element is composed of at least copper as anode electrode (=negative electrode or terminal). As cathode electrode (=positive electrode or terminal) the separate inner conductor element is composed of at least aluminium.

In accordance with a further aspect of the invention, the separate inner conductor element has a thickness of at least 1 mm, preferably of about 1.5 mm. The thickness can vary based on particular applications, e.g. of the size of the single electrochemical cell. The larger the cell is the lager is the thickness of the separate inner conductor element.

In a possible embodiment, the separate inner conductor element comprises a predetermined number of integrated bulges or knobs corresponding to the weld points integrated in the inner electrode conductor. Preferably, the inner electrode conductor comprises as welding points integrated bulges or knobs. Furthermore, the number of bulges or knobs integrated in the separate inner conductor element is the same number of weld points integrated in the inner electrode conductor. Such arrangement of connection points for welding connection of the inner electrode films through the inner electrode conductor with the separate inner conductor element allows a high space-saving and a high life expectancy and definite fixed connection with high current distribution.

In a further embodiment of the invention, an outward electrode conductor is connected to the separate inner conductor element and the inner electrode conductor through welding the integrated bulges or knobs of the separate inner conductor element and the integrated weld points of the inner electrode conductor.

In a possible embodiment, the outward electrode conductor comprises a predetermined number of integrated bulges or knobs which correspond with the number and form of the bulges or knobs of the separate inner conductor element and the weld points of the inner conductor and which are jointly welded, especially through ultrasonic welding.

Additionally, the outward electrode conductor is composed of at least copper coated with a protection layer. For a good protection against corrosion the protection layer is composed of stannous or nickel or an alloy, e.g. alloy of aluminium manganese or aluminium copper. Alternatively, the outward electrode conductor can be composed of at least copper with a treated surface, e.g. with a surface treated by an electronic beam.

In accordance with a further aspect of the invention, each outward electrode conductor has a thickness of at least 1 mm. The thickness can vary based on particular applications, e.g. of the size of the electrochemical cell. The larger the cell is the larger is the thickness of the outward electrode conductor. For example, the thickness should be in the range of about 1 mm to about 3 mm. This allows that an additional active electrode surface is given by the same cell outer surface because the required conductor section is provided by the new conductor thickness. Furthermore, such a conductor thickness allows a reduction of the transition surface between inner cell and outer cell, whereby the tightness in this transition surface is increased.

For connecting the electrochemical cell with other electrochemical cells each outward electrode conductor is connected with a respective outward terminal.

As a further aspect of the invention, an energy storage assembly is provided with definite and fail-safe connections of the electrochemical cells through so called poka-yoke (=a fail-safe contact in such a way that contact elements are designed that they do not misconnect with each other).

In accordance with an aspect of the invention, the energy storage assembly comprises a plurality of flat electrochemical cells, each of them comprises a pair of electrodes which electrically connect the electrochemical cells with each other through the outward terminals, wherein each electrochemical cell comprises as a pair of outward terminals a straight outward terminal and a curved outward terminal and wherein the electrochemical cells are connected with each other that a straight outward terminal of one of the electrochemical cell is connected with a curved outward terminal of an adjacent electrochemical cell.

Such design of the outward terminals allows that the electrochemical cells do not misconnect. Furthermore, this design allows an effective, space-saving arrangement of the electrochemical cells in a pack, e.g. in a battery or energy storage pack, in which the flat electrochemical cells are stacked on top of each other. Such a stack arrangement allows a simple and effective division of the stack into modules of a number of cells.

For a fixed, permanent, reliable connection with a high ampacity each outward terminal comprises at least one bulge, preferably two bulges.

In accordance with a further aspect of the invention, each outward terminal has a thickness of at least 1 mm. The thickness can vary based on particular applications, e.g. of the size of the energy storage assembly, especially of the size of the single electrochemical cell. The larger the assembly or cell is the larger is the thickness of the outward terminal. For example, the thickness should be in the range of about 1 mm to about 3 mm. This allows that an additional active electrode surface is given by the same cell outer surface because the required terminal section is provided by the new terminal thickness. Furthermore, such terminal thickness allows a reduction of the transition surface between inner cell and outer cell, whereby the tightness in this transition surface is increased.

In a possible embodiment of the invention, each outward terminal is composed of at least copper. In a further possible embodiment, each outward terminal is composed of at least copper coated with a protection layer. The protection layer is composed of e.g. stannous or nickel or an alloy, e.g. an alloy of aluminium manganese or aluminium copper.

Depending on the application the electrochemical cells are connected in series, parallelly or in parallel-series.

The invention can be used in electric cars, in hybrid electric vehicles, especially in parallel hybrid electric vehicles, serial hybrid electric vehicles or parallel/serial hybrid electric vehicles. Furthermore, the invention can be used also for storing wind energy or other produced energy, e.g. solar energy.

The present invention is now further described with particular reference to the following embodiments in the drawing. However, it should be understood that these embodiments are only examples of the many advantageous uses of the innovative teachings herein.

### BRIEF DESCRIPTION OF THE DRAWINGS

FIG. 1 shows a view of an energy storage assembly with a plurality of electrochemical cells which are connected with each other through pairs of outward terminals of each cell,

FIG. 2 shows a view of one of the electrochemical cells with inner and outward electrode conductors,

FIG. 3 shows a view of one of the electrochemical cells with outward electrode conductors, and

FIG. 4 shows a view of one of the separate inner conductor elements.

### DETAILED DESCRIPTION OF THE DRAWINGS

The present invention relates to an electrochemical cell and an energy storage assembly comprising a plurality of these cells. The invention can be used for different applications, e.g. in a hybrid electric vehicle, whereby the hybrid electric vehicle having a driving motor and an internal combustion engine, wherein the driving motor is driven by power supplied from the energy storage assembly. Alternatively, the energy storage assembly can also be used in an electric car having a driving motor driven by power supplied from the energy storage assembly. Furthermore the energy storage assembly can be used for storing wind or solar energy for which the assembly is integrated in a wind or solar energy plant.

FIG. 1 shows a view of an energy storage assembly 1 (also called battery pack) with a plurality of flat electrochemical cells 2 (also called battery cells or single galvanic cells or prismatic cells).

Each of the electrochemical cells 2 comprises a pair of electrodes A and K, whereby one of the electrodes A is an anode electrode and the other electrode K is a cathode electrode.

To electrically connect the electrochemical cells 2 with each other the electrodes A and K of each cell 2 are connected with outward terminals 3.A and 3.K. Depending on the application the electrochemical cells 2 can be connected through the outward terminals 3.A and 3.K in parallel, in series or in parallel-series.

The shown embodiment according to FIG. 1 presents electrochemical cells 2 which are connected in series.

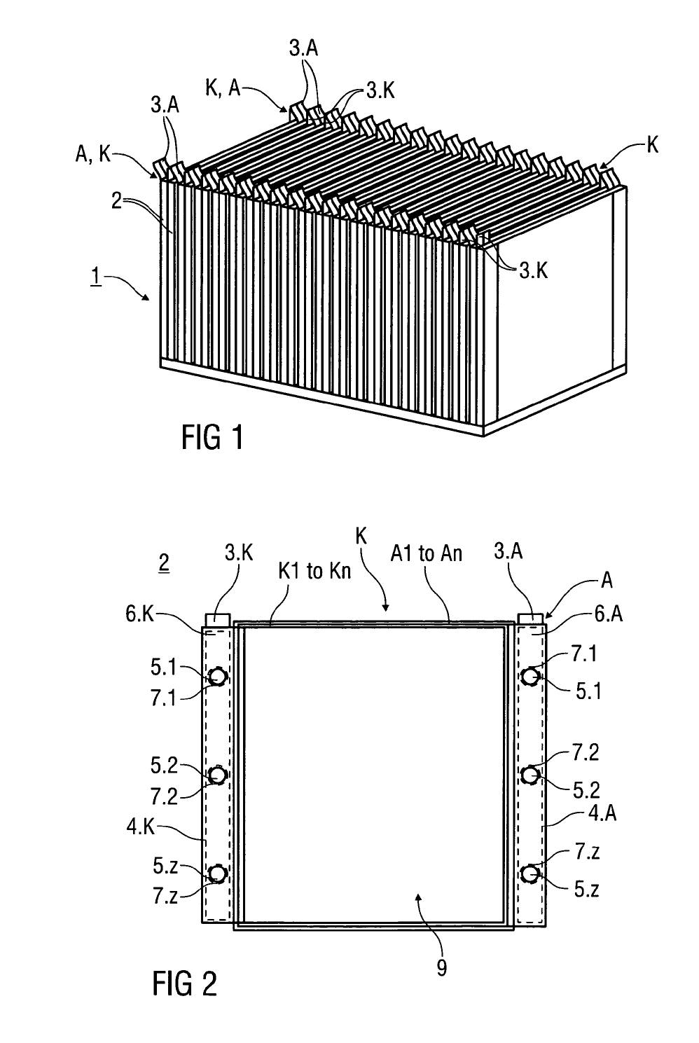

One of the electrochemical cell 2 is shown in FIG. 2 in more detail.

Each electrochemical cell 2 is a flat cell, which comprises e.g. as electrodes A and K a plurality of inner electrode films A1 to An and K1 to Kn, whereby different electrode films A1 to An and K1 to Kn separated by a not shown separator film. This separator film rinses with an e.g. non-aqueous electrolyte. Alternatively, instead of films for the electrodes A, K and the separator plates can be used.

Depending on the kind of cell 2, e.g. a lithium-ion cell; the electrode films A1 to An, K1 to Kn are divided in two different groups. One group of the electrode films A1 to

An represents the cathode or negative electrode K, e.g. of metal lithium, the other group of electrode films K1 to Kn represents the anode or positive electrode A, e.g. of lithium graphite.

For connecting the outward terminals 3.A, 3.K with the respective electrode A, K of each electrochemical cell 2 the cell 2 comprises inner electrode conductors 4.A, 4.K. In more detail, the inner electrode films A1 to An and K1 to Kn of the respective electrode A and K are electrically connected with each other through the inner electrode conductors 4.A and 4.K in that the inner electrode conductors 4.A and 4.K of the different electrodes A and K are arranged on opposite sides of the electrochemical cell 2 in electrode material-free area of the respective electrode films A1 to An and K1 to Kn.

For a fixed connection of the inner electrode films A1 to An and K1 to Kn of each electrode A and K, each inner electrode conductor 4.A and 4.K is provided with a predetermined number of weld points 5.1 to 5.z in the electrode material-free area of the respective electrode films A1 to An and K1 to Kn of the respective electrode A and K. Such fixed connection of the inner electrode films A1 to An and K1 to Kn allows also a fixed connection of the separator films arranged between the electrode films A1 to An, K1 to Kn.

Furthermore, each inner electrode conductor 4.A and 4.K is connected with a separate inner conductor element 6.A and 6.K, which is hidden (see dotted line for hidden separate inner conductor element 6.A and 6.K).

The separate inner conductor elements 6.A and 6.K are provided e.g. as an inner conductor bar. Preferably, the separate inner conductor element 6.K as the cathode electrode K is composed of at least aluminium. The other separate inner conductor element 6.A represents the anode electrode A and is composed of at least copper. Furthermore, each of the separate inner conductor elements 6.A, 6.K has a thickness of about 1 mm, especially of about 1.5 mm.

For connecting the separate inner conductor elements 6.A and 6.K with the inner electrode conductors 4.A, 4.K and the inner electrode films A1 to An and K1 to Kn the separate inner conductor elements 6.A and 6.K comprise a number of bulges 7.1 to 7.z or knobs or suchlike which correspond in form and number with the weld points 5.1 to 5.z of the inner electrode conductors 4.A, 4.K so that the welding is jointly done for connecting the inner electrode conductors 4.A, 4.K with the respective separate inner conductor elements 6.A, 6.K.

The bulges 7.1 to 7.z of the separate inner conductor elements 6.A, 6.K are protruded through a cell casing 9 surrounding the cell 2, e.g. a film casing, especially an aluminium laminated film casing.

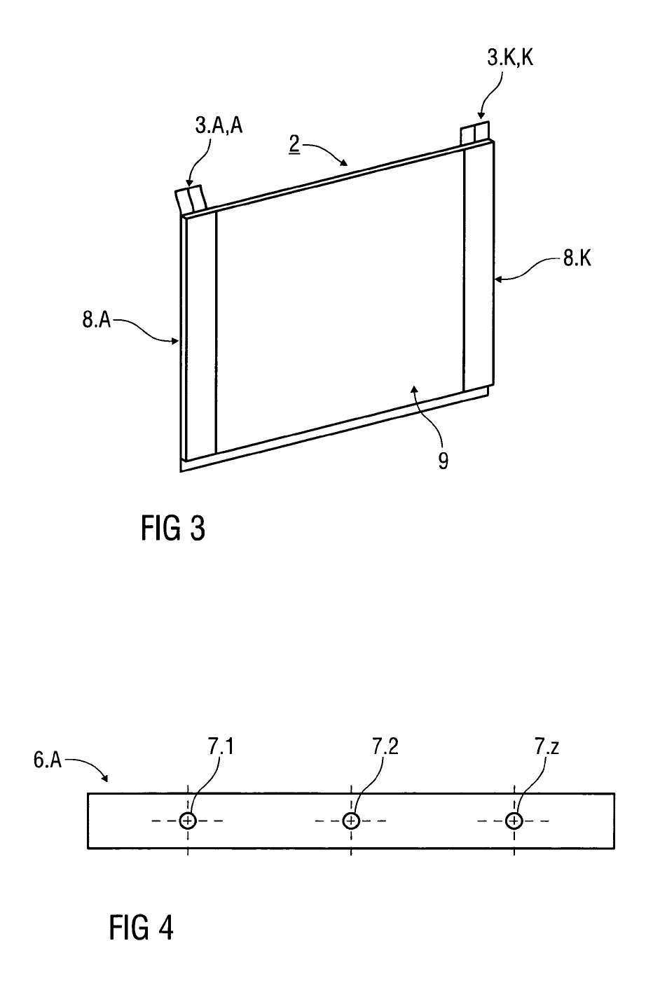

FIG. 3 shows outward electrode conductors 8.A, 8.K. One outward electrode conductor 8.A or 8.K represents one electrode A or K. The outward electrode conductors 8.A, 8.K are connected with the separate inner conductor elements 6.A, 6.K through jointly welded bulges or knobs. In detail, each outward electrode conductor 8.A, 8.K comprises a number of integrated bulges or knobs (not shown) which correspond in number and form with the integrated weld points 5.1 to 5.z of the inner electrode conductors 4.A, 4.K and the integrated bulges 7.1 to 7.z of the separate inner conductor elements 6.A, 6.K.

Preferably, the outward electrode conductors 8.A, 8.K can be composed of at least copper additionally coated with a protection layer which is composed of e.g. stannous or nickel or an alloy, e.g. an alloy of aluminium manganese or aluminium copper. The outward electrode conductors 8.A, 8.K can also be provided as a conductor bar.

Alternatively, the outward electrode conductors 8.A, 8.K can be composed of at least copper with a treated surface, e.g. with a surface treated by an electronic beam. Furthermore, each outward electrode conductor 8.A, 8.K has a thickness of at least 1 mm. The thickness can vary based on particular applications, e.g. of the size of the electrochemical cell 2. The larger the cell 2 is the larger is the thickness of the outward electrode conductors 8.A, 8.K. For example, the thickness should be in the range of about 1 mm to about 3 mm.

As shown in FIG. 3, each outward electrode conductor 8.A, 8.K is additionally connected with a respective outward terminal 3.A, 3.K.

Furthermore, the arrangement of electrode films A1 to An, K1 to Kn with separator films can be surrounded by a casing 9. The casing 9 can be provided as a film casing or a plate casing which isolates the cell 2 against other cells.

Preferably, the cells 2 are at least electrically isolated of each other. Additionally, the cells 2 can be thermally isolated of each other depending on the used material. Alternatively, the cells 2 can be electrically connected through the casing surface. Another alternative embodiment can be provided in that a material, e.g. a resin, is filled between the cells 2 for electrical isolation.

The whole energy storage assembly 1 can also be surrounded by a not shown casing, e.g. by a plate casing or a film casing (also called “soft-pack”).

Alternatively, sensor elements, such as temperature sensor elements, can be directly integrated in the outward terminal 3.A, 3.K. This allows a very efficient temperature measurement.

Especially, depending on the size of the energy storage assembly 1 the thickness of each outward terminal 3.A, 3.K can be varied in a range of 1 mm to 3 mm. In one embodiment, each outward terminal 3.A, 3.K can have a thickness of at least 1 mm.

Alternatively, the outward terminals 3.A, 3.K can have a different thickness in the above mentioned range depending on the available space and required compactness and tightness.

Furthermore, the outward terminals 3.A, 3.K can be formed differently in that the current distribution from the respective cell 2 is efficiently performed. For instance, the connecting end of each outward terminal 3.A, 3.K can have a cone form. The connecting end of each outward terminal 3.A, 3.K is the end through which the terminal 3.A, 3.K is connected with the respective outward electrode conductors 8.A, 8.K.

For fail-safe installation and assembling, especially a fail-safe connection of the electrochemical cells 2 with each other, the pair of outward terminals 3.A and 3.K of each cells 2 are differently designed in that one of the outward terminals, e.g. the outward anode terminal 3.A, has a straight form; the other outward terminal of the same cell 2, e.g. the outward cathode terminal 3.K, has a curved form or vice versa.

Furthermore, the outward terminals 3.A and 3.K of adjacent electrochemical cells 2, which are connected with each other, are also differently designed in that one of the connected outward terminals, e.g. the outward anode terminal 3.A, of one of the electrochemical cells 2 has a straight form; if these cells 2 are parallelly connected with each other the outward anode terminal 3.A of the adjacent electrochemical cell 2 has a curved form.

With other words: For a space-saving and fail-safe installation and assembling of the whole energy storage assembly 1 the electrochemical cells 2 are connected with each other that a straight outward terminal 3.A or 3.K of one of the electrochemical cells 2 is connected with a curved outward terminal 3.A or 3.K of an adjacent electrochemical cell 2 depending on the kind of connection, e.g. in parallel, in series or in parallel-series.

Preferably, each outward terminal 3.A, 3.K is composed of at least copper. Each outward terminal 3.A, 3.K is composed of the same material. This allows the same welding temperature. Furthermore, each outward terminal 3.A, 3.K can be composed of at least copper coated with a protection layer. Preferably, the protection layer is composed of stannous or nickel against corrosion. The protection layer is very thin. For instance, the protection layer has a thickness of a few μm.

FIG. 4 shows a possible embodiment of a separate inner conductor element 6.A with the integrated bulges 7.1 to 7.z for synchronous welding with integrated points 5.1 to 5.z of the respective inner electrode conductors 4.A and the not shown integrated bulges of the respective outward electrode conductor 8.A. The form and numbers of points 5.1 to 5.z and bulges 7.1 to 7.z can vary and depend on the application and/or size of the cell 2.

1.-21. (canceled)

22. Electrochemical cell with a pair of electrodes arranged as a stack of flat electrode films separated by a separator film,
wherein electrode films of each electrode are electrically connected with each other through inner electrode conductors,
wherein the inner electrode conductors of the electrodes are arranged on opposite sides of the electrochemical cell in an electrode material-free area of the electrode films,
wherein each inner electrode conductor is connected with a separate inner conductor element through a predetermined number of weld points integrated in the electrode material-free area of the respective electrode.

23. Electrochemical cell according to claim 22, wherein the separate inner conductor element is an inner conductor bar.

24. Electrochemical cell according to claim 22, wherein the separate inner conductor element is composed of at least copper as an anode electrode.

25. Electrochemical cell according to claim 22, wherein the separate inner conductor element is composed of at least aluminum as a cathode electrode.

26. Electrochemical cell according to claim 22 wherein the separate inner conductor element comprises a predetermined number of integrated bulges whose form corresponds to a form of weld points which are integrated in the inner electrode conductor.

27. Electrochemical cell according to claim 22, wherein the inner electrode conductor comprises, as welding points, integrated bulges or knobs.

28. Electrochemical cell according to claim 27, wherein a number of bulges integrated in the separate inner conductor element is the same number of weld points integrated in the inner electrode conductor.

29. Electrochemical cell according to claim 28, wherein an outward electrode conductor is connected to separate inner conductor elements and the inner electrode conductor through synchronous welding the integrated bulges and weld points.

30. Electrochemical cell according to claim 29, wherein the outward electrode conductor is composed of at least copper or aluminum coated with a protection layer.

31. Electrochemical cell according to claim 30, wherein the protection layer is composed of stannous or nickel or an alloy.

32. Electrochemical cell according to claim 31, wherein the alloy is either an alloy of aluminum manganese or aluminum copper.

33. Electrochemical cell according to claim 29, wherein the outward electrode conductor is composed of at least copper with a treated surface.

34. Electrochemical cell according to claim 33, wherein the surface is treated with an electronic beam.

35. Electrochemical cell according to claim 29, wherein each outward electrode conductor is connected with a respective outward terminal.

36. Electrochemical cell according to claim 22, wherein the bulges of the separate inner conductor elements are protruded through a cell casing surrounding the cell.

37. Electrochemical cell according to claim 34, wherein the cell casing is a film casing.

38. Electrochemical cell according to claim 34, wherein the film casing is an aluminum laminated film casing.

39. Energy storage assembly with a plurality of flat electrochemical cells according to claim 22.

40. Energy storage assembly according to claim 39, wherein each of the cells comprises a pair of electrodes which electrically connect the electrochemical cells with each other through outward terminals.

41. Energy storage assembly according to claim 39, wherein the electrochemical cells are connected in series.

42. Energy storage assembly according to claim 39, wherein the electrochemical cells are connected in parallel.

43. Energy storage assembly according to claim 39, wherein the electrochemical cells are connected in parallel-series.

44. An electric car having a driving motor driven by power supplied from the energy storage assembly according to claim 39.

45. A hybrid type electric car having a driving motor and an internal combustion engine, wherein the driving motor is driven by power supplied from the energy storage assembly according to claim 39.
